(19) United States
(12) Patent Application Publication
(10) Pub. No.: US 2021/0254649 A1
(43) Pub. Date: Aug. 19, 2021

(54) Furniture installation component

(71) Applicant: Cheng-Chen Chen, Taipei City (TW)

(72) Inventor: Cheng-Chen Chen, Taipei City (TW)

(21) Appl. No.: 16/792,315

(22) Filed: Feb. 17, 2020

(51) Int. Cl. F16B 12/40; F16B 12/36

(52) U.S. Cl. CPC F16B 12/40; A47B 2230/09; F16B 2012/403; F16B 12/36

(57) ABSTRACT

The present invention provides a furniture installation component comprises a connecting member, elastic members, a cross member and a T-shaped member. The elastic members are ring structures and covered on the grooves. The cross member is formed by connecting the first hollow pipe member and the second hollow pipe member, and has four first connecting holes. The T-shaped member is formed by connecting the third hollow pipe member and the fourth hollow pipe member, and the T-shaped member has three second connecting holes. The connecting member passes through the cross member and the T-shaped member through the first connecting hole and the second connecting hole. Therefore, the furniture installation component of the present invention can avoid the use of excessive hardware parts and tools, and can avoid the deterioration of the stability of the furniture after repeated disassembly and use, thereby facilitating the purpose of assembly, disassembly and carrying.

### TECHNICAL FIELD OF THE INVENTION

The present invention relates to a furniture installation component for detachable furniture; and more particularly to a furniture installation component without using excessive hardware parts and tools.

### DESCRIPTION OF THE PRIOR ART

Currently, the various parts of the furniture used in the room are usually connected by fixed connections to make the furniture too large; therefore, it is easy to cause damage during the transportation process. Additionally, the large volume of the furniture also increases the transportation cost. In order to overcome the above problems, many pieces of furniture are now detachable. When the furniture is transported or not in use, the parts of the furniture can be disassembled and packed to facilitate transportation and storage. Therefore, the space occupied by furniture is reduced and also reduces transportation costs. Simultaneously, it can also avoid the damage caused by collision during the transportation of furniture.

At present, various parts of detachable furniture usually are installed by screw and nut, and this connection method requires the cooperation of multiple tools before installation. Additionally, after repeated disassembly and use, the screw holes become larger and the stability of the connection is often worsened, and then the furniture cannot be used and waste is caused.

Therefore, there is a need for furniture installation components that can be easily disassembled and installed, so that users can achieve furniture disassembly without using too many hardware parts and tools. Therefore, how to solve the above problems, meet the needs of users and achieve convenient disassembly and assembly of furniture is the subject of urgent research in the technical field.

In the light of this, the inventor has invested a lot of research and development, and has continued to make breakthroughs and innovations in this field to solve the shortcomings with novel technological means. In addition to bringing better products to society, it also promotes industrial development.

### SUMMARY OF THE INVENTION

The main purpose of the present invention is to provide a furniture installation component, which can avoid the use of excessive hardware parts and tools, and can avoid the deterioration of furniture stability after repeated disassembly and use; therefore, the present invention can achieve the purpose of disassembly and carrying. Further, the same set of furniture installation component of the present invention is used to change into different furniture, which can change multiple styles of furniture and make good use of interior space.

To achieve the above object, the present invention provide a furniture installation component is composed of a connecting member, a plurality of elastic members, a cross member and a T-shaped member. Firstly, the connecting member is a hollow cylinder and has a plurality of grooves on its surface, and the plurality of grooves is equidistantly arranged on the connecting member. Secondly, each of the plurality of elastic members is a ring structure and is covered on the plurality of grooves; and the cross member is composed of a first hollow pipe member and a second hollow pipe member, and has four first connecting holes. Furthermore, the T-shaped member is composed of a third hollow pipe member and a fourth hollow pipe member, and has three second connecting holes; wherein the connecting member is passed through the cross member through the first connecting hole, and the connecting member is passed through the T-shaped member through the second connecting hole.

The plurality of elastic members comprises a first elastic member and a second elastic member. The first elastic member is covered on one of plurality of grooves in the middle of the connecting member, and the second elastic members are covered on the rest of the plurality of grooves of the connecting member. The first elastic member has a first external diameter and a first internal diameter; and the second elastic member has a second external diameter and a second internal diameter. The first internal diameter is equal to the second internal diameter; and the first external diameter is greater than the second external diameter.

The first external diameter is larger than the diameters of the first connecting hole and the second connecting hole, and the second external diameter is smaller than the diameters of the first connecting hole and the second connecting hole. When the connecting member passes through the cross member, the first elastic member is abutted on the first connecting hole; and when the connecting member passes through the T-shaped member, the first elastic member is abutted on the second connecting hole.

The cross member consists of two first hollow pipe members and one second hollow pipe member. The surface of the second hollow pipe member has two opposite first openings, so that the two first hollow pipe members are vertically connected to the second hollow pipe member, respectively.

A first elastic pad is provided at the internal connection of the two first hollow pipe members and the second hollow pipe member of the cross member, and the first elastic pad has a first opening hole.

The T-shaped member is composed of a third hollow pipe member and a fourth hollow pipe member, and the third hollow pipe member has a second opening on its surface, so that the fourth hollow pipe member is vertically connected to the second opening.

A second elastic pad is provided at the internal connection of the third hollow pipe member and the fourth hollow pipe member of the T-shaped member, and the second elastic pad has a second opening.

The cross member and the T-shaped member are integrally formed.

The connecting member, the cross member, and the T-shaped member are made of a metal material or a metal alloy material.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded view of a furniture installation component according to a first embodiment of the present invention;

FIG. 2 is schematic view of installing a connecting member, elastic members and a cross member according to the first embodiment of the present invention;

FIG. 3 is schematic view of installing the connecting member, elastic members and a T-shaped member according to the first embodiment of the present invention;

FIG. 4 is an exploded view of connecting member and elastic members according to the first embodiment of the present invention;

FIG. 5a is schematic view of the first elastic member according to the first embodiment of the present invention;

FIG. 5b is schematic view of the second elastic member according to the first embodiment of the present invention; and

FIG. 6 is an exploded view of a furniture installation component according to a second embodiment of the present invention.

### DETAILED DESCRIPTION OF THE PREFERRED EMBODIMENTS

In the following paragraphs, a detailed description is provided for a thorough understanding of the figures listed above. Well-known structures and devices will also be used schematically for better comprehension.

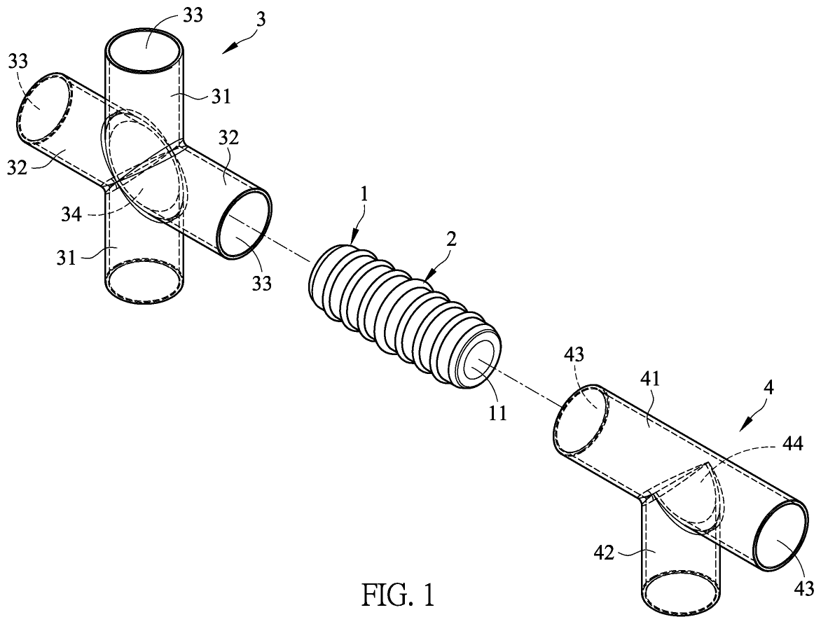

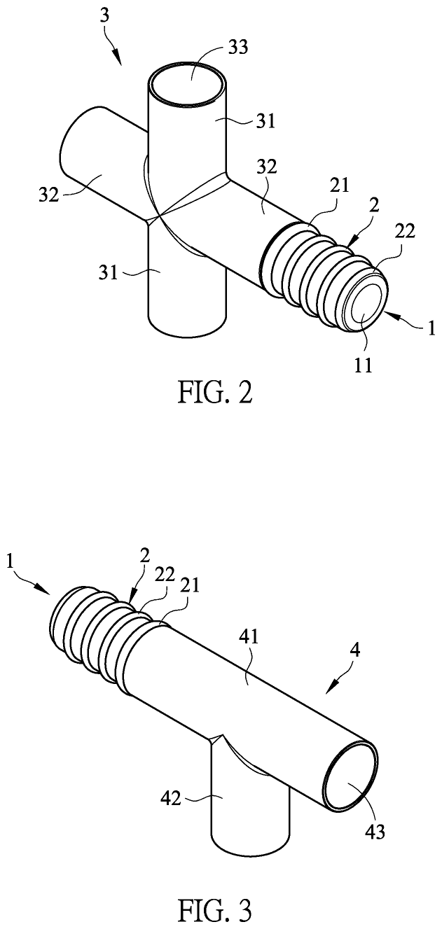

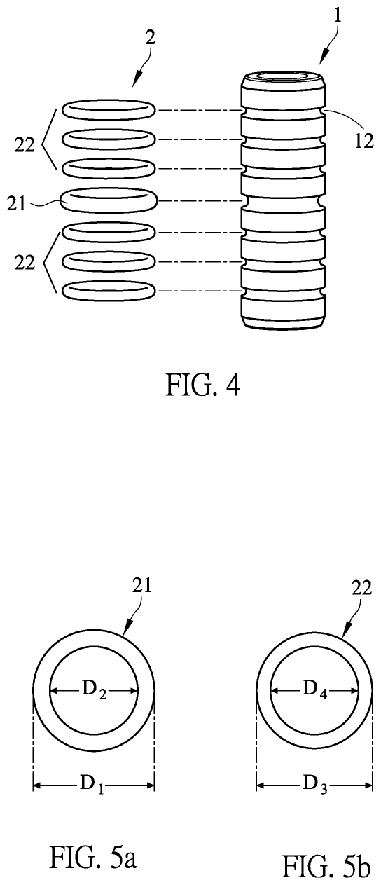

Please refer to FIG. 1 to FIG. 4, FIG. 1 is an exploded view of a furniture installation component according to a first embodiment of the present invention; FIG. 2 is schematic view of installing a connecting member, elastic members and a cross member according to the first embodiment of the present invention; FIG. 3 is schematic view of installing the connecting member, elastic members and a T-shaped member according to the first embodiment of the present invention; and FIG. 4 is an exploded view of connecting member and elastic members according to the first embodiment of the present invention.

As seen in FIG. 1 and FIG. 4, the present invention provide a furniture installation component is composed of a connecting member 1, a plurality of elastic members 2, a cross member 3 and a T-shaped member 4. Firstly, the connecting member 1 is a hollow cylinder and has a plurality of grooves 12 on its surface of the connecting member 1, and the plurality of grooves 12 are equidistantly arranged on the connecting member 1. Secondly, each of the plurality of elastic members 2 is a ring structure and is covered on the plurality of grooves 12. Further, the cross member 3 is composed of two first hollow pipe member 31 and a second hollow pipe member 32, and has four first connecting holes 33; wherein the second hollow pipe member 32 has two opposite first openings 34 on the surface thereof, so that the two first hollow pipe member 31 are vertically connected to the two opposite first openings 34 respectively. Furthermore, the T-shaped member 4 consists of a third hollow pipe member 41 and a fourth hollow pipe member 42, and has three second connecting hole s 43; wherein the third hollow pipe member 41 has a second opening 44 on the surface thereof, so that the fourth hollow pipe member 42 is vertically connected to the second opening 44, and the length of the third hollow pipe member 41 of the T-shaped member 4 is longer than the fourth hollow pipe member 42 of the T-shaped member. As seen in FIG. 2 and FIG. 3, the connecting member 1 is passed through the cross member 3 through the first connecting hole 33, and the connecting member 1 is passed through the T-shaped member 4 through the second connecting hole 43; wherein the connecting member 1 is a hollow cylinder 11. When the connecting member 1 passes through the first hollow pipe member 31, the second hollow pipe member 32, the third hollow pipe member 41, or the fourth hollow pipe member 42, the air in these hollow pipe members will be pushed out of the hollow cylinder 11 by the pushing of the connecting member 1 and discharged out of the hollow pipe members. Therefore, it can avoid the excessive air inside these hollow pipe members to prevent the connecting member 1 from being pushed in, and can also reduce the weight of the entire installation component.

The plurality of elastic members 2 are made of a plastic or rubber material; wherein the compositions of the plastic or the rubber material may be randomly varied based on the user's requirements. The plastic material can be acrylonitrile butadiene styren, epoxy resin, polyamide, polyimide, polyamide-imide, polyacrylic acid, polybutene, polycarbonate, polyethylene, polyetheretherketone, polyethylene terephthalate, phenol formaldehyde, polyisobutylene, polylactic acid, polymethylmethacrylate, polyoxymethylene, polypropylene, polystyrene, plastarch material, polysulfone, polytetrafluoroethene, polyurethane, polyvinyl alcohol, polyvinyl chloride, polyphenylene sulfide, polybenzothiazole or polybenzimidazole, but the present invention is not limited thereto. Further, the rubber material can be polybutadiene rubber, styrene-butadiene rubber, nitrile butadiene rubber, chloroprene rubber, ethylene-propylene rubber, polysulfide rubber, acrylate rubber, fluororubber, silicone rubber, isobutylene-isoprene rubber, or polyisoprene rubber, but the present invention is not limited thereto.

Furthermore, the connecting member 1, the cross member 3, and the T-shaped member 4 are made of a metal material or a metal alloy material. The sort of the metal material may be randomly varied based on the user's requirements, and the sort of the metal material may be at least one selected from the group consisting of iron, copper, aluminum, tin, nickel, silver, lead, and zinc. Additionally, the metal alloy material may be randomly varied based on the user's requirements, and the sort of the metal alloy material may be at least one selected from the group consisting of iron alloy, copper alloy, aluminum alloy, tin alloy, nickel alloy, silver alloy, lead alloy, zinc alloy, and combinations thereof.

Please refer to FIG. 5a and FIG. 5b, FIG. 5a is schematic view of the first elastic member according to the first embodiment of the present invention; and FIG. 5b is schematic view of the second elastic member according to the first embodiment of the present invention.

As seen in FIG. 5a and FIG. 5b, the plurality of elastic members 2 comprise a first elastic member 21 and a second elastic member 22. The first elastic member 21 is covered on the plurality of groove 12 in the middle of the connecting member 1, and the second elastic member 22 is covered on the rest of plurality of grooves 12 of the connecting member 1. Further, the first elastic member 21 has a first external diameter D1 and a first internal diameter D2. The second elastic member 22 has a second external diameter D3 and a second internal diameter D4. The first internal diameter D2 is equal to the second internal diameter D4 and the first external diameter D1 is larger than the second external diameter D3. Additionally, the second external diameter D3 is smaller than the diameters of the first connecting hole 33 and the second connecting hole 43, so that the connecting member 1 can pass through the cross member 3 and the T-shaped member 4. Secondly, the first external diameter D1 is larger than the diameters of the first connecting holes 33 and the second connecting hole 43; therefore, when the connecting member 1 passes through the cross member 3, the first elastic member 21 is abutted on the first connecting hole 33; when the connecting member 1 passes through the T-shaped member 4, the first elastic member 21 is abutted on the second connecting hole 43.

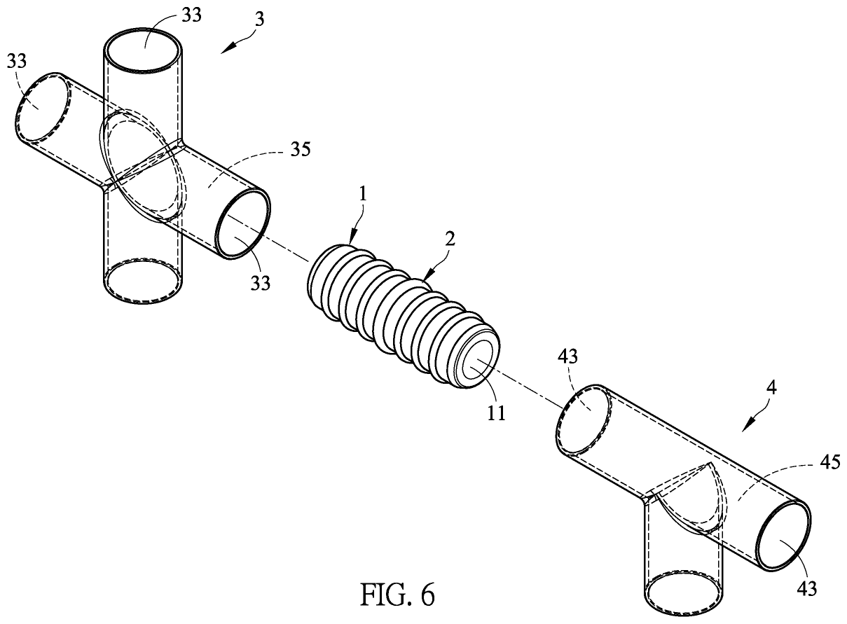

Please refer to FIG. 6, FIG. 6 is an exploded view of a furniture installation component according to a second embodiment of the present invention.

The second embodiment of the present invention is substantially the same as the furniture installation assembly described in the first embodiment. The difference is that the cross member 3 and the T-shaped member 4 of first embodiment are separate members and are connected to each other by welding, but the cross member 3 and the T-shaped member 4 of the second embodiment are integrally formed. As seen in FIG. 6, the cross member 3 of the furniture installation component is composed of a cross-shaped hollow connecting pipe, and has four first connecting holes 33 and a first communication space 35. Further, the T-shaped member 4 is composed of a T-shaped hollow connecting pipe, and has three second connecting holes 43 and a second communication space 45; wherein the connecting member 1 passes through the cross member 3 through the first connecting hole 33, and the connecting member 1 passes through the T-shaped member 4 through the second connecting hole 43.

The above descriptions for each figure explain the principles of the disclosure and its practical applications. The embodiments depicted above and the appended drawings are exemplary and are not intended to be exhaustive or to limit the scope of the disclosure. Modifications and variations are possible in view of the above teachings.

I claim:

1. A furniture installation component, comprising:
a connecting member to be a hollow cylinder having a plurality of grooves on its surface, and the plurality of grooves are equidistantly arranged on the connecting member;
a plurality of elastic members that each of the plurality of elastic members is a ring structure and is covered on the plurality of grooves;
a cross member composed of a first hollow pipe member and a second hollow pipe member, and having four first connecting holes; and
a T-shaped member composed of a third hollow pipe member and a fourth hollow pipe member, and has three second connecting holes;
wherein the connecting member passes through the cross member through the first connecting hole, and the connecting member passes through the T-shaped member through the second connecting hole.

2. The furniture installation component mentioned in claim 1, wherein the plurality of elastic members comprise a first elastic member and a second elastic member; the first elastic member is covered on one of the plurality of grooves in the middle of the connecting member, and the second elastic member is covered on the rest of grooves of the connecting member; the first elastic member has a first external diameter and a first internal diameter; the second elastic member has a second external diameter and a second internal diameter; the first internal diameter is equal to the second internal diameter; and the first external diameter is greater than the second external diameter.

3. The furniture installation component mentioned in claim 2, where the first external diameter is larger than the diameters of the first connecting hole and the second connecting hole, and the second external diameter is smaller than the diameters of the first connecting hole and the second connecting hole; when the connecting member passes through the cross member, the first elastic member is abutted on the first connecting hole; and when the connecting member passes through the T-shaped member, the first elastic member is abutted on the second connecting hole.

4. The furniture installation component mentioned in claim 1, where the cross member is composed by connecting two first hollow pipe members and one second hollow pipe member, the surface of the second hollow pipe member has two opposite first openings, so that the two first hollow pipe members are vertically connected to the two opposite first openings, respectively.

5. The furniture installation component mentioned in claim 1, wherein a first elastic pad is provided at the internal connection of the two first hollow pipe members and the second hollow pipe member of the cross member, and the first elastic pad has a first opening hole.

6. The furniture installation component mentioned in claim 1, wherein the T-shaped member is composed of a third hollow pipe member and a fourth hollow pipe member, and the third hollow pipe member has a second opening on its surface, so that the fourth hollow pipe member is vertically connected to the second opening.

7. The furniture installation component mentioned in claim 6, wherein a second elastic pad is provided at the internal connection of the third hollow pipe member and the fourth hollow pipe member of the T-shaped member, and the second elastic pad has a second opening.

8. The furniture installation component mentioned in claim 1, wherein the cross member and the T-shaped member are integrally formed.

9. The furniture installation component mentioned in claim 1, wherein the connecting member, the cross member, and the T-shaped member are made of a metal material or a metal alloy material.
